(19) United States
(12) Patent Application Publication
(10) Pub. No.: US 2023/0074519 A1
(43) Pub. Date: Mar. 9, 2023

(54) Systems and Methods for Biological Sample Collection

(71) Applicant: Northwestern University, Evanston, IL (US)

(72) Inventors: Thomas W. McDade, Evanston, IL (US); William E. Funk, Evanston, IL (US)

(21) Appl. No.: 17/898,181

(22) Filed: Aug. 29, 2022

Related U.S. Application Data
(60) Provisional application No. 63/237,910, filed on Aug. 27, 2021.

(51) Int. Cl. G01N 1/31; B01L 3/00; G01N 1/40

(52) U.S. Cl. CPC G01N 1/31; B01L 3/508; G01N 1/4077; G01N 2001/4088; B01L 2300/105; B01L 2300/0609; B01L 2300/0809; B01L 2300/047; B01L 2300/021; B01L 2200/141

(57) ABSTRACT

A container for collecting a sample is provided that can include a housing, an enclosure pivotally coupled to and slidably engaged with the housing, and a sample holder slidably engaged with and received within the enclosure. The sample holder can include a substrate configured to receive the sample. The container in a first configuration can include the enclosure being engaged with the housing to enclose and seal the substrate within an interior volume of the container. The container in a second configuration can include the enclosure exposing the substrate to the ambient environment.

### CROSS-REFERENCE TO RELATED APPLICATIONS

This application claims priority to U.S. Provisional Patent Application No. 63/237,910, filed Aug. 27, 2021, which is incorporated herein by reference in its entirety.

### STATEMENT REGARDING FEDERALLY SPONSORED RESEARCH

Not applicable.

### BACKGROUND

Filter paper (e.g., Whatman #903 paper) is used to collect blood samples to detect contaminants in the blood (e.g., heavy metals). However, current sample collection methods can negatively impact safety of personnel conducting the procedure, can negatively impact accuracy of testing of contaminants, and can decrease the speed of the testing process. Thus, it would be desirable to have improved systems and methods for biological sample collection.

### SUMMARY OF THE DISCLOSURE

Some embodiments of the disclosure provide a container for collecting a sample. The container can include a housing, an enclosure that is configured be pivotally coupled to and slidably engaged with the housing, and a sample holder slidably engaged with and received within the enclosure. The sample holder can include a substrate configured to receive the sample. The container in a first configuration can include the enclosure being engaged with the housing to enclose and seal the substrate within an interior volume of the container. The container in a second configuration can include the enclosure exposing the substrate to the ambient environment.

The foregoing and other aspects and advantages of the present disclosure will appear from the following description. In the description, reference is made to the accompanying drawings that form a part hereof, and in which there is shown by way of illustration one or more exemplary versions. These versions do not necessarily represent the full scope of the disclosure.

### BRIEF DESCRIPTION OF THE DRAWINGS

The following drawings are provided to help illustrate various features of non-limiting examples of the disclosure, and are not intended to limit the scope of the disclosure or exclude alternative implementations.

FIG. 1 shows a rear perspective view of a container in a first configuration.

FIG. 2 shows a rear perspective view of the container of FIG. 1 in a second configuration.

FIG. 3 shows a perspective view of the sample holder of FIG. 1.

FIG. 4 shows a front perspective view of the container of FIG. 1 in a third configuration.

### DETAILED DESCRIPTION OF THE PRESENT DISCLOSURE

Filter paper is an established substrate for the collection and preservation of samples, including whole blood. Typically, the sample after being collected on the filter paper is allowed to dry in the ambient environment to preserve the sample on the paper. In this way, quantification of the amount of blood and thus concentration of contaminants in the blood can be more accurate when dried as it is associated with a surface area on the filter paper. In other words, if blood does not completely dry on the filter paper, the amount of blood analyzed is artificially high due to remaining water and thus the calculated concentration of contaminates would be lower than the actual concentration. In addition, allowing blood to completely dry mitigates pathogen exposure to laboratory personal as there is a significantly lower risk from pathogen transmission from being exposed to dried blood as opposed to liquid blood. Once the blood sample is dried and preserved on the filter paper, the dried samples can be shipped and stored prior to laboratory analysis.

In some cases, it can take up to two or more hours to adequately dry the blood sample on the filter paper, which involves exposing the filter paper to the ambient environment during drying. However, exposing the filter paper to the ambient environment can increase the risk of biohazard exposure (e.g., pathogen exposure) to personnel interacting with the filter paper, and can lead to sample contamination (e.g., external contaminates contacting the filter paper). For example, particulates floating in the ambient environment can be lodged onto the filter paper or the sample, which can disrupt proper accurate sample analysis.

Some embodiments of the disclosure provide advantages to these issues (and others) by providing improved systems and methods for biological sample collection. For example, some embodiments of the disclosure provide a biological sample container that can contain a substrate having a biological sample thereon, and can seal the substrate from the ambient environment while the biological sample dries. In this way, the sample container can protect the filter paper from contamination before collection, and the sample after collection. In some configurations, the sample container can include a built-in desiccant, which can facilitate drying of the biological sample by absorbing water vapor inside the container when the substrate is sealed from the ambient environment. In this way, the biological sample is not required to be exposed to the ambient environment to dry the sample (e.g., for two hours), which can expose the sample to contamination, and can limit the ability to collect samples. For example, by drying the biological sample while sealed from the ambient environment facilitates faster and more efficient sample collection (e.g., because the samples do not have to be left out for at least two hours, which may prevent sample collection in some areas, including those in which the humidity is too high in the ambient environment).

In some embodiments, the sample container can be easy to hold in a practitioner's hand (e.g., is ergonomic), regardless of the configuration of the sample container (e.g., whether the sample container is enclosed, open, etc.). In some cases, the sample container can include a housing, an enclosure pivotally coupled to the housing, and a sample holder received within the enclosure. The housing can be pivoted about the enclosure to move the housing past the substrate thereby freeing the substrate from being situated within the housing. In this way, the substrate can be placed into contact with a sample without requiring the practitioner to grasp the substrate. Thus, the practitioner can simply continue holding the housing, which can be more rigid than the substrate (e.g., a filter paper), to bring the substrate into contact with the sample. This can facilitate sample collection as typical systems are difficult to hold, contain flaps that interfere with sample collection, or require the practitioner to remove the substrate and bring the flimsy substrate into contact with the sample, each of which can interfere with proper sample collection (e.g., introducing smearing, blotting, etc., of the sample on the substrate that can interfere with proper blood quantification).

In some embodiments, the sample container can be used for collecting biological samples, or other samples that are not necessarily biological (e.g., but may include biological components). For example, the sample container can be used for biological samples including blood from humans (e.g., in a community, in a hospital-based setting, in research and health screenings, in self-collection at home, etc.), blood from animals (e.g., in veterinary applications, in farm applications including those for farm animals, etc.), other biological fluids including saliva, urine, breastmilk, etc. As another example, the sample container can be used for other samples (e.g., that are not necessarily biological in nature) including water from water sources (e.g., in environmental sampling, household water quality testing, well water testing, etc.).

In some embodiments, the sample container can include a substrate that is a filter paper. Filter paper has been routinely used to collect capillary blood for more than 60 years as part of hospital-based neonatal metabolic screening programs. It is also now used for a wide range of clinical, research, and direct-to-consumer testing purposes, primarily focusing on blood. However, as assay (and other) technology improves, it is becoming possible to quantify more and more markers in smaller and smaller volumes of blood. In addition, other bodily fluids including saliva, urine, and breastmilk can be tested. In these cases, the use of filter paper reduces the cost of sample collection, and increases convenience in transporting and shipping dried samples. For example, dried samples are more stable than liquid samples, dried samples take up less space and are easier to ship than liquid samples, and dried samples are not subject to the same level of biohazard regulation (e.g., due to less issues with transmissibility of blood borne pathogens). The sample container described herein can utilize filter paper (e.g., to take advantage of the benefits of a filter paper-based sample collection processes and systems), while overcoming the disadvantages associated with current dried blood collection systems.

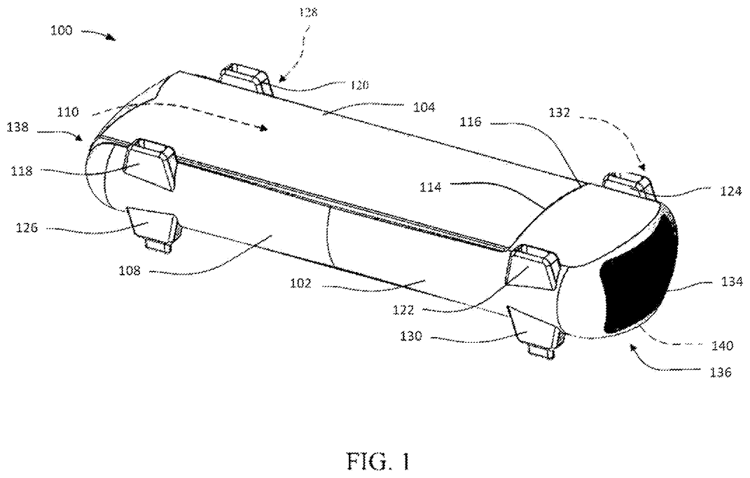

FIG. 1 shows rear isometric view of a container 100 for collecting samples (e.g., biological samples) in a first configuration. The container 100 can include a housing 102 and an enclosure 104. The housing 102 can define a body 108 with a u-shape profile, while the enclosure 104 can have a rectangular profile. In other configurations, however, the housing 102 and the enclosure 104 can have other shapes. The container 100 can have an internal volume 110 which can be defined by the housing 102 and the enclosure 104. The internal volume 110 can be sealed from the ambient environment (e.g., the air surrounding the container 100) to protect a sample contained within. For example, the interior volume 110 can be sealed when the enclosure 104 is engaged with the housing 102. In the first configuration, a peripheral edge 114 of the enclosure 104 can engage with and contact a peripheral edge 116 of the housing 102. As a more specific example, when the peripheral edge 114 of the enclosure 104 can engages with and contacts the peripheral edge 116 of the housing 102 as shown in FIG. 1, the interior volume 110 is sealed from the ambient environment. In a non-limiting example, one of the peripheral edge 114 or the peripheral edge 116 can include a gasket to mitigate fluid communication between the interior volume of the housing and the ambient environment

In some embodiments, the housing 102 can include legs 118, 120, 122, 124, 126, 128, 130, 132 that extend away from the housing 102. For example, the legs 118, 120, 122, 124 are integrally formed with (or are coupled to) a top side of the housing 102, while the legs 126, 128, 130, 132 are integrally formed with (or are coupled to) a bottom side of the housing 102 (e.g., opposite the top side of the housing). As shown in FIG. 1, each of the legs 118, 120, 122, 124 can include a recess directed into a top surface of a free end of the respective leg, while the legs 126, 128, 130, 132, can include a protrusion extending from a lower surface of a free end of the respective leg. The recesses in the top surface of legs 118, 120, 122, and 124 have a depth and shape complementary the protrusions from legs 126, 128, 130, and 132, such that the recesses can receive and removably retain the protrusions. In this way, another container 100 (not shown) can be stacked on top of the container 100, or the container 100 can be stacked on the another container 100 for secure transport and storage. For example, the another container 100 can be structured in a similar manner as the container 100 and thus each protrusion of each leg of the another container 100 that extends from the bottom side of the another container 100 is inserted into respective recess of each leg 118, 120, 122, 124. In some cases, the engagement between a protrusion and a recess can be a snap-fit engagement. In some configurations, while the housing 102 is illustrated as having four legs extending from the bottom side and the top side, in other configurations, the housing 102 can include other numbers of legs (e.g., one, two, three, four, etc.). Additionally, and alternatively, the housing 102 can include side legs with recesses and legs with protrusions extending from the body 108. Such side legs would allow the container 100 to be joined side-by-side to another container 100, or a stack of containers 100 could be stabilized by joining with another stack of containers 100.

In some embodiments, the container 100 can include a chamber 134. The housing 102 can include a first end 136 opposite a second end 138 of the housing. The chamber 134 can be coupled to and in engagement with the housing 102. For example, the chamber 134 can be engaged with the housing 102 at the first end 136 of the housing 102.

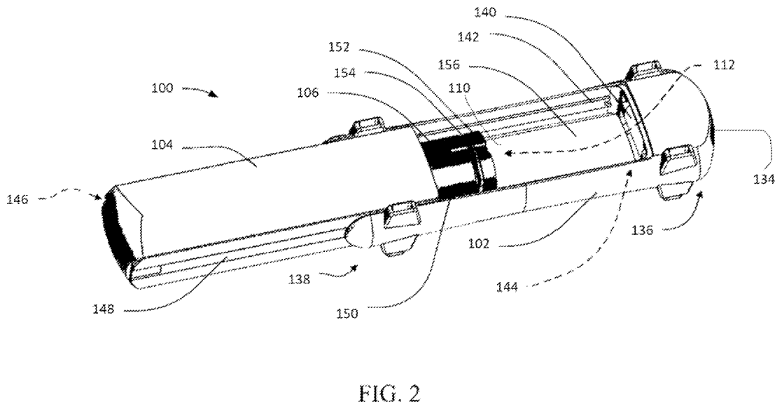

FIG. 2 shows a rear isometric view of the container 100 in a second configuration. The enclosure 104 can be slideably engaged with and can be pivotally coupled to the housing 102 (or vice versa). For example, the enclosure 104 can slide along the housing 102 (e.g., while the housing 102 is fixed) from the first configuration to the second configuration, or the housing 102 can slide along the enclosure 104 (e.g., while the enclosure 104 is fixed) from the first configuration to the second configuration. As a more specific example, the housing 102 can include protrusions 142, 144 positioned on opposing lateral sides of the housing 102 and extending along the housing 102 from a location proximate to the first end 136 and to a location proximate the second end 138. Correspondingly, the enclosure 104 can include channels 146, 148 positioned on opposing lateral sides of the enclosure 104. Each protrusion 142, 144 is received within a respective channel 146, 148 and each channel 146, 148 slides along the respective protrusion 142, 144 as the enclosure 104 slides along the housing 102.

In some configurations, the housing 102 can be pivotally coupled to the enclosure 104 (or vice versa). In this way, the housing 102 can rotate about the enclosure 104, or the enclosure 104 can rotate about the housing 102. In some cases, the housing 102 (or the enclosure 104) can rotate only after the enclosure 104 slides to extend a predetermined distance from the housing 102. For example, each protrusion 142, 144 can include a cylinder coupled to or internally formed with the respective protrusion (e.g., at an end, or other portion of the respective protrusion) proximate to the second end 138 of the housing 102. Correspondingly, each channel 146, 148 can include a cylindrical bore in fluid communication with the respective channel 146. In some cases, each bore can be directed into an end of each channel 146, 148 proximate the end of the enclosure 104 that includes the opening that defines the cavity 112. Regardless, each cylinder of each protrusion 142, 144 can engage with a respective cylindrical bore of a respective channel 146, 148 so that housing 102 can rotate about the enclosure 104 (or vice versa). For example, as the enclosure 104 is slid along the housing 102, each cylinder of each protrusion 142, 144 slides along a respective channel until each cylinder engages (e.g., snaps into engagement) with a respective cylindrical bore of the respective channel. At this point, the housing 102 can rotate about the cylindrical bores, but is blocked from sliding. However, once the housing 102 (or the enclosure 104) is rotated substantially (i.e., deviating by less than 10% from) 180 degrees, 360 degrees, etc., forcing of the enclosure 104 in a direction towards the first side 136 of the housing 102 removes the cylinders from each cylindrical bore and forces the protrusions 142, 144 into engagement with the respective channel 146, 148 thereby sliding the enclosure 104 towards the first side 136 of the housing 102, while blocking rotation of the enclosure 104 about the housing 102 (and vice versa).

In some embodiments, when the enclosure 104 is configured to slide relative to the housing 102, the enclosure 104 is blocked from rotating about the housing 102. Similarly, when the enclosure is configured to rotate relative to the housing 102, the enclosure 104 is blocked from sliding along the housing 102. In some configurations, the protrusions 142, 144 can extend substantially linearly along a length of the housing 102 (e.g., defined from the first end 136 to the second 138 of the housing 102), and the channels 146, 148 can extend substantially linearly along a length of the enclosure 104. In this way, the enclosure 104 slides in a straight manner along the housing 102.

In some embodiments, while the housing 102 has been described as including protrusions 142, 144 (and cylinders) and the enclosure 104 has been described as including channels 146, 148 (and cylindrical bores), any protrusion can be replaced with a corresponding slot (and vice versa) as appropriate. In addition, each cylinder can be replaced with each cylindrical bore (and vice versa) as appropriate. As an example, the enclosure 104 can include the protrusions 142, 144 (and the cylinders), while the housing 102 can include the channels 146, 148 (and the cylindrical bores).

The enclosure 104 can have a cavity 112, which can include a sample positioned therein. The sample holder 106 can be coaxially received within the cavity 112 of the enclosure 104, and can be slideably engaged within the cavity 112. For example, the sample holder 106 can be slid out of the cavity 112 as the enclosure 104 is slid along the housing 102. Thus, in some cases, the length of the cavity 112 can be longer than the length of the sample holder 106. In some embodiments, the sample holder 106 can include a body 150, an extension 152 coupled to the body 150, a gasket 154, and a substrate 156. As shown in FIG. 2, the substrate 156 can extend through the extension 152, and can be coupled to the body 150 (e.g., via the extension 152). For example, the extension 152 that can retain the substrate 156 and can be removably coupled to the body 150 (e.g., at a free end of the body 150 that is positioned outside of the cavity 112). In this way, the substrate 156 can be removed from the extension 152 to test the sample loaded on the substrate 156, and the sample holder 106 can be reused by engaging (and coupling) another extension 152 to the body 150.

In some configurations, the substrate 156 can be planar, and can be formed out of different materials. For example, the substrate 156 can be filter paper. Regardless of the configuration, the substrate 156 can be configured to wick away and absorb a liquid (e.g., a bodily fluid, such as blood). In some cases, the substrate 156 can include indicia, which can include, for example, a barcode, a data matrix, an identifier, a serial number, a shape (e.g., a circle), etc.

In some cases, the chamber 134 can be removably coupled with the housing 102. For example, the chamber 134 can be removed and replaced. In one non-limiting example, the container 100 can include a desiccant 140 that is contained within chamber 134. Thus, after a period of time during which the desiccant has absorbed water vapor or liquid from the sample, the desiccant 140 can be replaced. The chamber 134 can be decoupled from the housing 102, the used desiccant 140 removed, the new desiccant 140 inserted, and the chamber 134 coupled to the housing 102.

Regardless of the configuration, the chamber 134 can define an interior space that can be in fluid communication with the interior volume 110 of the enclosure 104 when the container 100 is in the first configuration (e.g., the enclosure 104 is in a first configuration in which the enclosure 104 contacts the housing 102). In this way, the sample can be in fluid communication with the desiccant 140 while the container 100 is sealed from the ambient environment as shown in FIG. 1. In this arrangement, the desiccant 140 captures water vapor from the atmosphere inside the container, thereby assisting the drying of the sample.

As shown in FIG. 2, when the container 100 is in the second configuration, the substrate 156 is exposed to the ambient environment, and is situated between opposing walls of the housing 102. In some configurations, the container 100 in the second configuration can be moved into the first configuration by sliding the enclosure 104 towards the first end 136 of the housing 102 until the enclosure 104 contacts the housing 102. As the enclosure 104 is slid along the housing 102, the sample holder 106 slides back into the cavity 112. In some cases, the sample disposed on the substrate 156 is in fluid communication with the chamber 134 that includes the desiccant 140 when, for example, the container 100 is in the first configuration. In some cases, the chamber 134 can include a clip that retains the desiccant 140 within the chamber 134. In this way, the desiccant 140 can be replaced by another desiccant 140 when, for example, the desiccant 140 has exceeded its lifetime use.

In some embodiments, the sample holder 106 can be pivotally coupled to the housing 102. In this way, as the enclosure 104 is slid along the housing 102 (or vice versa), the sample holder 106 maintains a consistent position (e.g., relative to the housing 102) so that the sample holder 106 (and the substrate 156) can be advanced into (or out of) the cavity 112. In other words, by the sample holder 106 being pivotally coupled to the housing 102, the sample holder 106 is blocked from sliding along with the enclosure 104 (or the housing 102). In some configurations, the housing 102 can include pins that are received within respective bores of the enclosure 104, while in other configurations, the housing 102 can have bores that receive respective pins of the enclosure 104.

In some embodiments, the chamber 134 rather than being removably coupled from the housing 102 can form part of the housing 102. For example, one or more walls of the housing 102 can define the chamber 134. In this case, then, the clip that retains the desiccant 140 can be coupled to the housing 102 (e.g., at a wall of the housing 102).

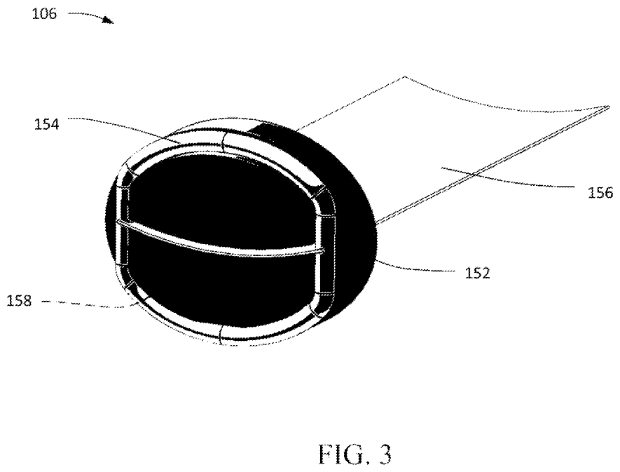

FIG. 3 shows a rear isometric view of the sample holder 106 with the body 150 omitted for visual clarity. As shown in FIG. 3, the extension 152 includes a slit 158 directed therethrough that receives the substrate 156. For example, an end of the substrate 156 is inserted through the slit 158 thereby retaining the substrate 156 to the extension 152. In some cases, the substrate 156 can be retained by the extension 152 within the slit 158 (e.g., in a press-fit like manner). In addition, the engagement between the substrate 156 and the extension 152 can be reinforced by using the gasket 154. For example, the gasket 154 can retract around a peripheral recess of the extension 152 and can contact opposing lateral ends of the substrate 156 to further secure the substrate 156 to the extension 152. In some cases, the gasket 154 can be positioned between opposing ends of the substrate 156 (e.g., the ends of which define the length of the substrate 156).

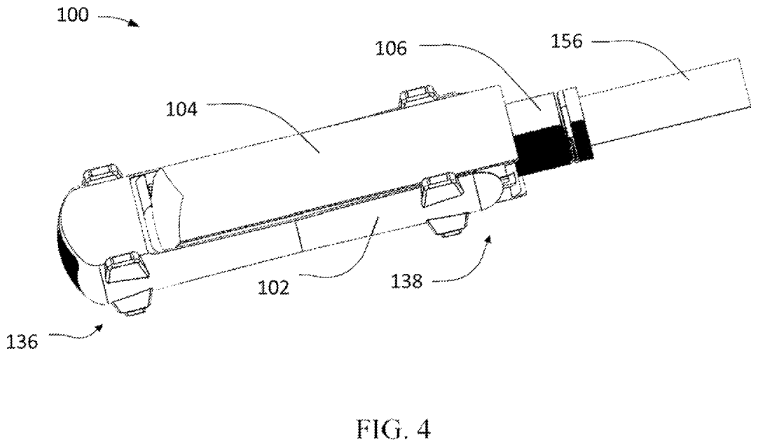

FIG. 4 shows a rear isometric view of the container 100 in a third configuration. In some cases, the container 100 can transition from the second configuration to the third configuration by rotating the housing 102 about the enclosure 104 or rotating the enclosure 104 about the housing 102 (e.g., when the cylinders are inserted into the cylindrical bores). In some cases, the enclosure 104 can be slid back towards the first end 136 of the housing 102 from the third configuration until the protrusions 142, 144 reengage the channels 146, 148 to define a fourth configuration (e.g., which can include the cylinders disengaging with the respective cylindrical bores). In this way, while in the fourth configuration, rotation between the housing 102 and the enclosure 104 is restricted, which can make sample collection easier (e.g., because the substrate 156 is blocked from undesirable rotation during engagement with a sample). As shown in FIG. 4, the substrate 156 is positioned away from the housing 102 by a separation distance. In addition, the substrate 156 can extend away from both ends 136, 138 of the housing 102, which can facilitate easier sample collection. For example, the substrate 156 can move past the housing 102 to the third and fourth configuration of the container 100 that frees the substrate 156 from being constrained by the housing 102.

In some embodiments, the container 100 can move between the four different configurations, as appropriate. For example, the container 100 can move in the reverse order from the fourth configuration, to the third configuration, to the second configuration, and back to the first configuration.

In operation, the container 100 can move from the first configuration as shown in FIG. 1 to the second configuration shown in FIG. 2 by sliding the enclosure 104 along the channels 146, 148. As the enclosure 104 slides, the substrate 156 and sample holder 106 are revealed. In this configuration, the substrate 156 and sample holder are exposed to the ambient environment. Access to the substrate 156 is partially blocked by the opposing walls of the housing 102. Once the enclosure 104 is fully extended, the container 100 can adopt the third configuration by pivoting the enclosure 104 by 180 degrees relative to the housing 102 such that the enclosure 104 is situated between the opposing walls of the housing 102. In this configuration, the sample holder 106 and substrate 156 are fully exposed. The practitioner can collect a sample by grasping the enclosure 104 along with the housing 102 and contacting the substrate 156 to the sample or depositing the sample onto the substrate 156. Additionally, and alternatively, the sample holder 106 and/or substrate 156 may be removed or replaced while the container 100 is in the third configuration.

Once the substrate 156 has received the sample, the enclosure 104 can slide along the channels 146, 148 to cover the substrate. Alternatively, the enclosure 104 can pivot 180 degrees relative to the housing 102 such that the substrate 156 is in position between the opposing walls of the housing 102. In this configuration, the substrate 156 is partially protected from contamination or physical contacts. The enclosure 104 can slide along the channels 146, 148 to return to the first configuration. In this configuration, the substrate 156 is enclosed. The peripheral edge 114 makes a sealing contact with peripheral edge 116 such that the liquids from the environment are prevented from contacting the substrate 156 within cavity 112. When the container 100 is in the first configuration, the sample on the substrate 156 is protected from contamination.

In another non-limiting example, the sample on the substrate 156 can be analyzed while held by the sample holder 106 in the container 100 in the third configuration or by removing the substrate from the container 100.

In yet another non-limiting example, a portion of the substrate can be cut, excised, punched out, or otherwise removed for analysis, while the remainder of the substrate 156 with the sample thereon is stored within the container 100 or elsewhere as a reserve sample. After the portion of the substrate is removed for analysis, the reserved portion of the substrate and reserved sample thereon may be protected from contamination by returning the container 100 to the first configuration.

In some embodiments, the sample may be analyzed by eluting one or more components of the sample from the substrate or removed portion of the substrate 156, and detecting for the one or more the analytes of interest in the eluent. Any appropriate form of analysis can be used (e.g., destructive methods, spectroscopic) to detect analytes of interest in the sample as eluted from the substrate or alternatively the substrate can be analyzed directly. The examples given are not meant to be limiting.

If a desiccant 140 is included in the chamber 134, the sample can dry while held inside the container 100. If numerous samples are collected, the containers 100 can be stacked to improve the user experience by saving space. Because the container 100 can be stacked with another of container 100, the user is provided with a means of organizing the container 100. By way of non-limiting example, the containers can be stacked according to subject, chronology, type of sample, location the sample was collected, or any other criteria as designated by the practitioner.

Some embodiments of the disclosure can provide a self-contained collection device that protects filter paper from contamination before and after collection. In some embodiments, a desiccant can be built into the device can protect the sample and can facilitate transportation of the sample immediately after collection, with no waiting time for drying (e.g., because the sample can dry while being enclosed by the device). In some cases, different types of filter paper can be inserted into the device, which can increase flexibility for different applications. In some configurations, the device can be easily held, which can enhance control during sample collection thereby increasing the quality of the sample collected. In some cases, the device can include an attachment point for the filter paper, so the filter paper can be easily installed and removed. In some configurations, the device can include a clip that holds onto a desiccant cartridge, which can be easily replaced.

Some embodiments of the disclosure overcome the limitations of previous devices that make it more difficult to apply samples to filter paper. In addition, the embodiments disclosed herein can be designed for flexibility in application, and can be used to collect capillary whole blood, saliva, urine, breastmilk, etc. Thus, human, veterinary, and other applications are possible. The device can also be used for environmental sampling to facilitate, for example, testing of domestic water sources for contamination with lead. In some applications, drying of the sample can advantageously be completed while the sample remains protected during transport and storage (e.g., which can facilitate faster sample collection).

The present disclosure has described one or more preferred embodiments, and it should be appreciated that many equivalents, alternatives, variations, and modifications, aside from those expressly stated, are possible and within the scope of the invention.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

What is claimed is:

1. A container for collecting a sample, the container comprising:
a housing;
an enclosure pivotally coupled to and slidably engaged with the housing;
a sample holder slidably engaged with and received within the enclosure;
a substrate that receives the sample, wherein the substrate is removably fixed to the sample holder; and
the container in a first configuration includes the enclosure being engaged with the housing to enclose and seal the substrate within an interior volume of the container, and
the container in a second configuration includes the enclosure exposing the substrate to the ambient environment.

2. The container of claim 1, wherein the enclosure in the first configuration is configured to slide along the housing to the second configuration, and
wherein as the enclosure slides along the housing the sample holder slides out of the enclosure.

3. The container of claim 1, wherein the substrate is positioned between opposing sides of the housing when the enclosure is in the second configuration.

4. The container of claim 3, wherein when the enclosure is in the second configuration at least one of:
the housing is configured to be pivoted about the enclosure so that the enclosure is in a third configuration; or
the enclosure is configured to be pivoted about the housing so that the enclosure is in a third configuration, and
wherein when the container is in the third configuration, the substrate extends away from a first side the housing and a second side of the housing opposite the first side of the housing.

5. The container of claim 1, further comprising a desiccant positioned within the housing.

6. The container of claim 5, wherein the desiccant is in fluid communication with the substrate when the enclosure is in the first configuration, such that the desiccant captures water vapor from the atmosphere inside the container.

7. The container of claim 1, wherein the housing includes at least one of a protrusion or a channel,
wherein the enclosure includes the other of the at least one of the protrusion or the channel, and
wherein the protrusion slidingly engages with the channel to slide the enclosure along the housing.

8. The container of claim 1, wherein the enclosure includes a first channel and a second channel opposite the first channel, and
wherein the housing includes a first protrusion and a second protrusion opposite the first protrusion, and
wherein the first protrusion is configured to slidably engage with the first channel, and the second protrusion is configured to slidably engage with the second channel.

9. The container of claim 3, wherein the sample holder is coaxially received within the enclosure, and
wherein with the enclosure fixed, the housing slides past the enclosure to surround at least a portion of the substrate.

10. The container of claim 1, wherein the enclosure includes a bore, and wherein the sample holder is received within the bore of the enclosure.

11. The container of claim 1, further comprising a chamber coupled to the housing, the chamber being in fluid communication with the interior volume of the housing, and
wherein the chamber is dimensioned to receive a desiccant.

12. The container of claim 11, wherein the chamber is removably coupled to the housing, and
wherein the chamber is part of a clip that snaps onto the housing.

13. The container of claim 1, further comprising a gasket coupled to a peripheral edge of the housing, and
wherein the gasket generates a seal between the enclosure and the housing to mitigate fluid communication between the interior volume of the housing and the ambient environment.

14. The container of claim 1, wherein the substrate includes a filter paper, and
wherein the filter paper includes indicia that includes at least one of a circle, or a barcode.

15. The container of claim 1, wherein the housing has a u-shaped profile, and wherein the enclosure has a rectangular profile.

16. The container of claim 1, wherein the sample holder includes a slit to receive and retain the substrate.

17. The container of claim 16, wherein the sample holder includes a protrusion extending from a body of the sample holder that includes the slit.

18. The container of claim 1, wherein the enclosure comprises at least one cylinder or at least one cylindrical bore, wherein the housing includes the other of at the least one cylinder or at least one cylindrical bore, such that the enclosure and the housing can be pivotably coupled by at least one cylinder received by at least one cylindrical bore when the container is in the second configuration.

19. A method of sample collection using the container of claim 1 comprising: sliding the enclosure to extend away from the housing and reveal the substrate; pivoting the enclosure relative to the housing to fully expose the substrate; collecting the sample on the substrate; closing the container by pivoting the enclosure relative to the housing and sliding the enclosure towards the housing.

20. A method for analyzing a sample within the container of claim 1 comprising: sliding the enclosure to extend away from the housing to reveal the substrate having a sample thereon; pivoting the enclosure relative to the housing to fully expose the substrate having the sample thereon; and analyzing the sample for one or more analytes of interest.

21. The method of claim 20, wherein analyzing the sample for one or more analytes of interest comprises: removing the substrate or a portion of the substrate having the sample thereon; eluting one or more components of the sample from the removed portion of the substrate; and detecting for the one or more the analytes of interest in the eluent.

22. The method of claim 21, wherein a portion of the substrate is removed and the method further comprises storing a reserved portion of the substrate and any reserved sample thereon by returning the container to the first configuration.
